(19) United States
(12) Patent Application Publication
(10) Pub. No.: US 2010/0119756 A1
(43) Pub. Date: May 13, 2010

(54) Partially pre-printed label for food products

(75) Inventors: Charles M. Kahler, Chesapeake, VA (US); Timothy H. Henry, Windsor, VA (US); Larry W. Evancho, Chesapeake, VA (US)

Correspondence Address: Kaufman & Canoles c/o Kelly Brown, P.O. Box 3037, Norfolk, VA, 23514-3037, US

(73) Assignee: Southern Atlantic Label Company, Inc., Chesapeake, VA (US)

(21) Appl. No.: 12/589,648

(22) Filed: Oct. 27, 2009

Related U.S. Application Data
(60) Provisional application No. 61/197,426, filed on Oct. 27, 2008.

(51) Int. Cl. G09F 3/10; B32B 38/10; B32B 38/14

(52) U.S. Cl. 428/40.1; 156/152

(57) ABSTRACT

A novel method to provide a consumer printable label. The method includes an adhesive-backed stock layer which may be printed on both surfaces. Following the desired printing, an ultraviolet varnish is applied to a portion of the stock surface which is not adhesive backed and an adhesive laminate covers the stock surface, including the portion to which the ultraviolet varnish was applied. The laminate is then removed from the portion of the stock layer to which the ultraviolet varnish was applied. This portion of the label may be printed by the consumer while the remainder of the label remains protected by the laminate which was not removed.

### CROSS REFERENCE TO RELATED APPLICATION

The present application claims priority from U.S. Provisional Application Ser. No. 61/197,426, filed Oct. 27, 2008.

### BACKGROUND OF THE INVENTION

1. Field of the Invention

The present invention relates to a label for food products, and, more particularly to a partially pre-printed label for food products and method for manufacturing such label.

2. Description of Related Art

There are many circumstances in which label assemblies are desirable for packaging products and particularly food products. A common problem with label assemblies, however, when used for packaging products (such as food items) is that the label does not allow for printing by the seller of the product. Preprinted labels are generally coated with a laminate layer which is not amenable to printing. The seller must then place an additional label on the product in order to include additional information on the packaging such as weight or price.

An object of the present invention is to provide a label for products.

An object of the present invention is to provide a label for products which includes a protected preprinted portion.

Another object of the present invention is to provide a label for products which includes a portion which may be printed by the end user.

Finally, it is an object of the present invention to accomplish the foregoing objectives in a simple and cost effective manner.

### SUMMARY OF THE INVENTION

The present invention addresses these needs by providing a label assembly which includes a first layer having an adhesive-backed stock layer which has front and back opposite faces. The stock layer is preferably about 4 millimeters in thickness and the adhesive backing is preferably about 2 millimeters in thickness. The adhesive backing is preferably an acrylic base adhesive. The adhesive-backed face is attached to a liner. The front and back of the stock layer are capable of accepting printed information. A portion of the front face of the stock layer includes a UV varnish layer. A laminate layer, preferably acrylic based and approximately 2 millimeters in thickness, covers the front surface of the stock layer such that the laminate layer may be removed from the portion of the front face of the stock layer to which the UV varnish layer has been applied. The laminate layer adheres to the remaining portion of the front face of the stock layer to which the UV varnish layer has not been applied.

A method for producing the described printable label, proceeds by providing a first layer having an adhesive-backed stock layer attached to a liner and separating the liner from the stock layer. The stock layer is preferably about 4 millimeters in thickness and the adhesive backing is preferably about 2 millimeters in thickness. The adhesive backing is preferably an acrylic base adhesive. Data is then printed on either or both sides of the adhesive-backed stock layer and the liner is relaminated to the adhesive backed stock layer. A UV varnish layer is applied to a portion of the front face of the stock layer. A laminate layer, preferably acrylic based and approximately 2 millimeters in thickness, is applied to the front surface of the stock layer and then removed from the portion of the front face of the stock layer to which the UV varnish was applied.

### BRIEF DESCRIPTION OF THE DRAWINGS

A more complete description of the subject matter of the present invention and the advantages thereof, can be achieved by reference to the following detailed description by which reference is made to the accompanying drawings in which:

FIG. 1 shows delamination of the stock from the liner according to the preferred embodiment of the present invention;

FIG. 2 shows printing of the adhesive surface of the stock according to the preferred embodiment of the present invention;

FIG. 3 shows relamination of the stock to the liner following printing of the adhesive surface of the stock according to the preferred embodiment of the present invention;

FIG. 4 shows application of ultraviolet (“UV”) varnish to a portion of the front surface of the stock according to the preferred embodiment of the present invention;

FIG. 5 shows application of a laminate to the front surface of the stock according to the preferred embodiment of the present invention;

FIG. 6 shows cutting of the laminate from the portion of the front surface of the stock to which UV varnish was applied in preparation for removal according to the preferred embodiment of the present invention;

FIG. 7 shows removal of the laminate from the portion of the front surface of the stock to which UV varnish was applied according to the preferred embodiment of the present invention;

FIG. 8 shows a completed label according to the preferred embodiment of the present invention;

FIG. 9A shows a cross-sectional view across line I-I of FIG. 8 of the laminate protected portion of the completed label, according to the preferred embodiment of the present invention; and

FIG. 9B shows a cross-sectional view across line II-II of FIG. 8 of the printable portion of the completed label, according to the preferred embodiment of the present invention.

### ELEMENT LIST

10 liner
12 laminated portion of label
14 unlaminated, printable portion of label
16 adhesive on stock
18 stock
20 adhesive on laminate
22 laminate
24 UV varnish

### DETAILED DESCRIPTION OF THE PREFERRED EMBODIMENT

The following detailed description is of the best presently contemplated mode of carrying out the invention. This description is not to be taken in a limiting sense, but is made merely for the purpose of illustrating general principles of embodiments of the invention.

A single label for products is provided which includes a laminated portion and an unlaminated portion such that the end user is able to print its desired information on the unlaminated portion while the laminated portion remains protected.

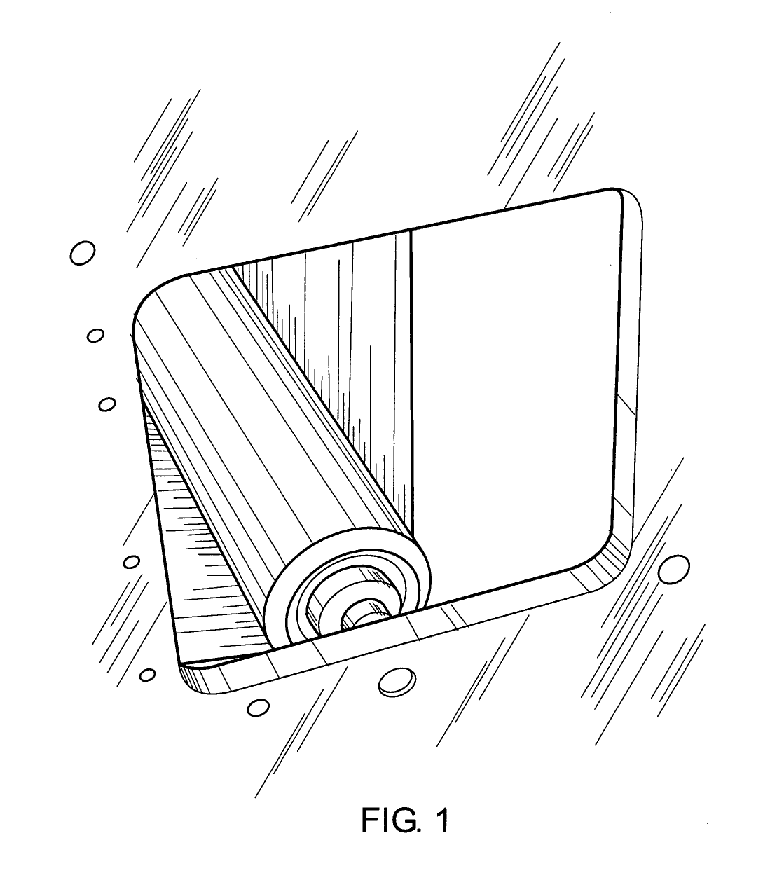

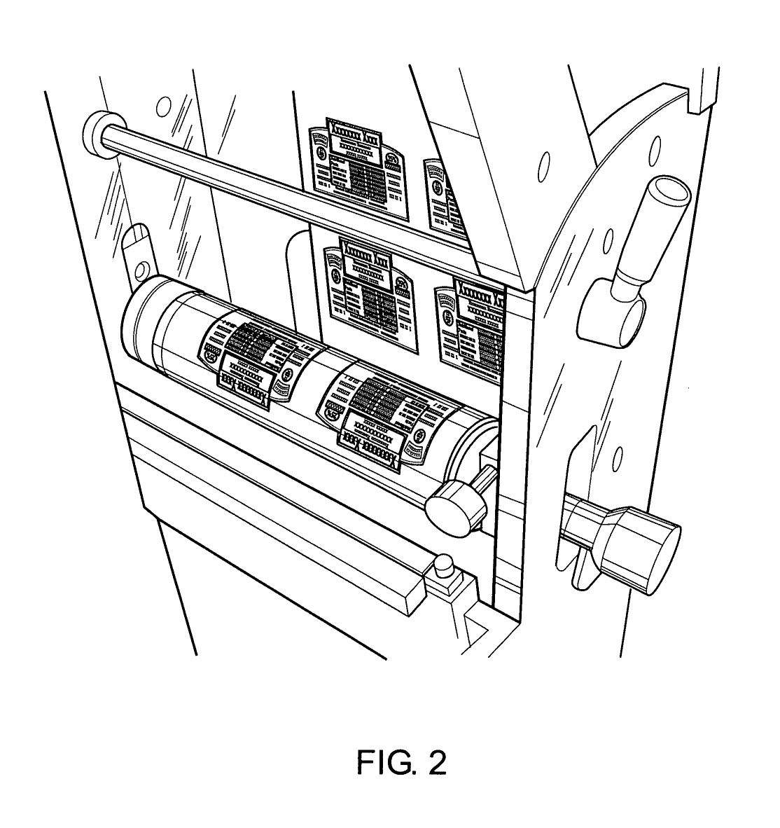

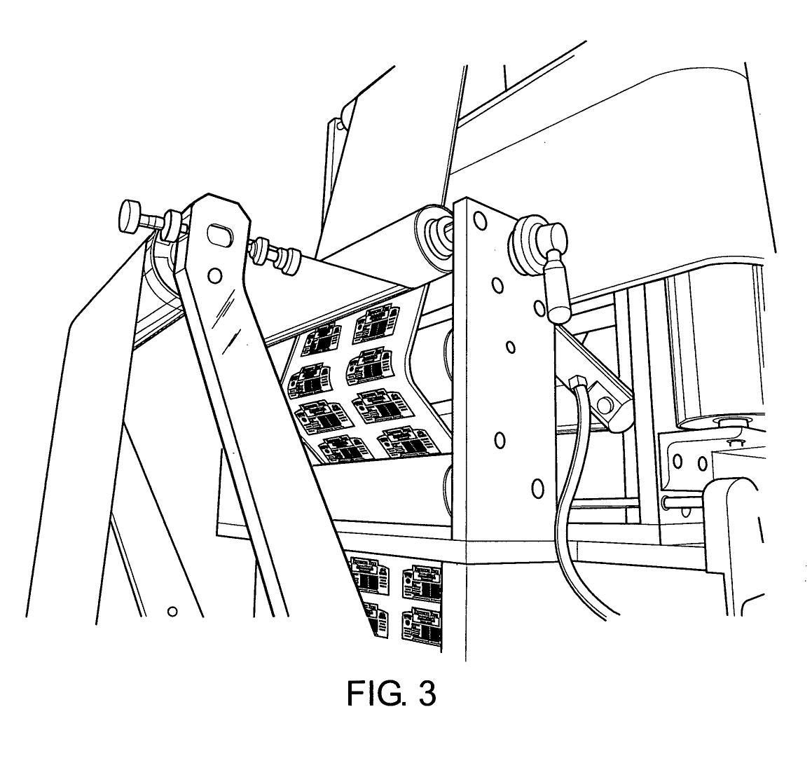

The process is run through a printing press and begins with plain, adhesive-backed 16 stock 18 which back is attached to a liner 10. In the current embodiment, the stock has a 40 lb liner, 4.1 mm stock sheet and 2 mm lam adhesive. Any stock 18 appropriate for labels can be used in the process. The adhesive 16 is preferably an acrylic base adhesive. In the first step of the process, the liner 10 is separated (see FIG. 1) from the stock 18 to allow for printing on the rear side of the label (see FIG. 2), i.e., the side which was previously attached to the liner 10. After printing the copy (text and/or graphics) on the rear side of the label, use a printing plate to deaden ⅛ inch of adhesive 16 on the bottom of the back side of the label at the customer printable portion. The liner 10 and stock 18 are then reattached (see FIG. 3) and turned over.

The following step is to print a portion of the front surface of the label, i.e., the surface which is not adjacent to the liner 10. This is the preprinted portion as directed by the customer. The remaining portion (the “customer print portion” 14) is treated such that the customer is able to print on the label once they receive the completed label.

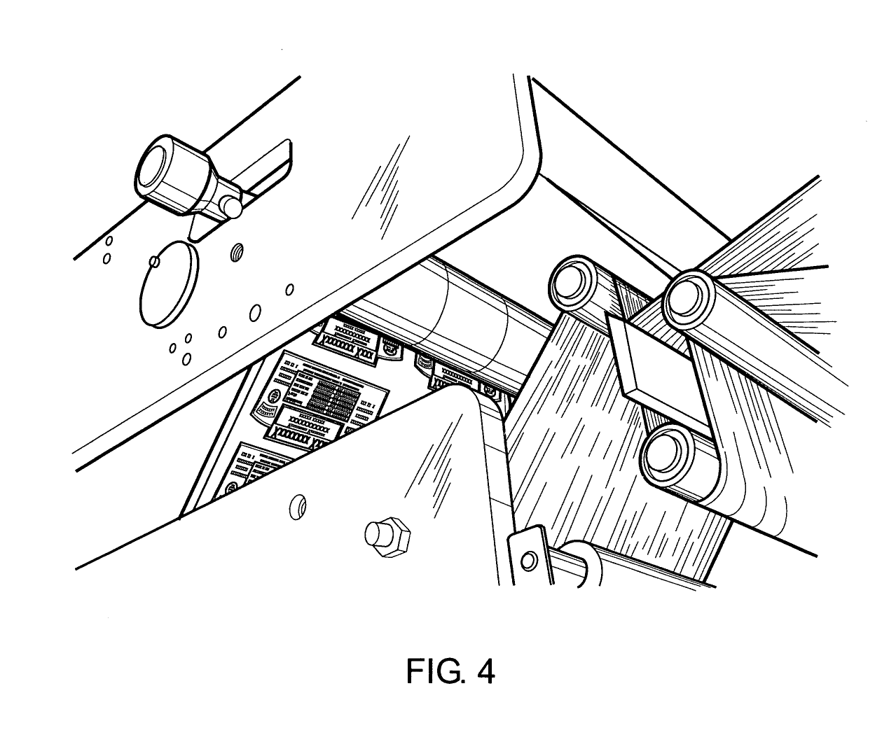

To treat the customer print portion of the label, a UV treatment is applied to the customer print portion of the label (see FIG. 4). In the preferred embodiment, UV varnish 24 (deadener) is used for deadener so that the laminate (applied later) releases more easily off the customer print portion of the face stock 18. A cyrel plate is used to transfer the UV 24 to the face stock 18. The plate is preferably a Dupont Cyrel TLC 0.067. The UV varnish is obtained from Acteta WIT.

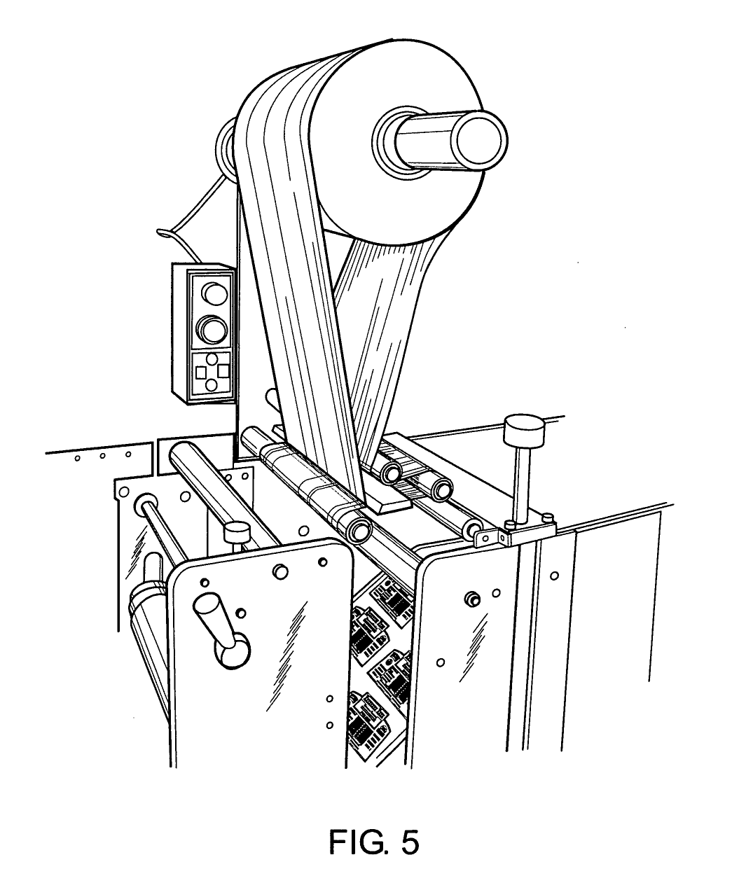

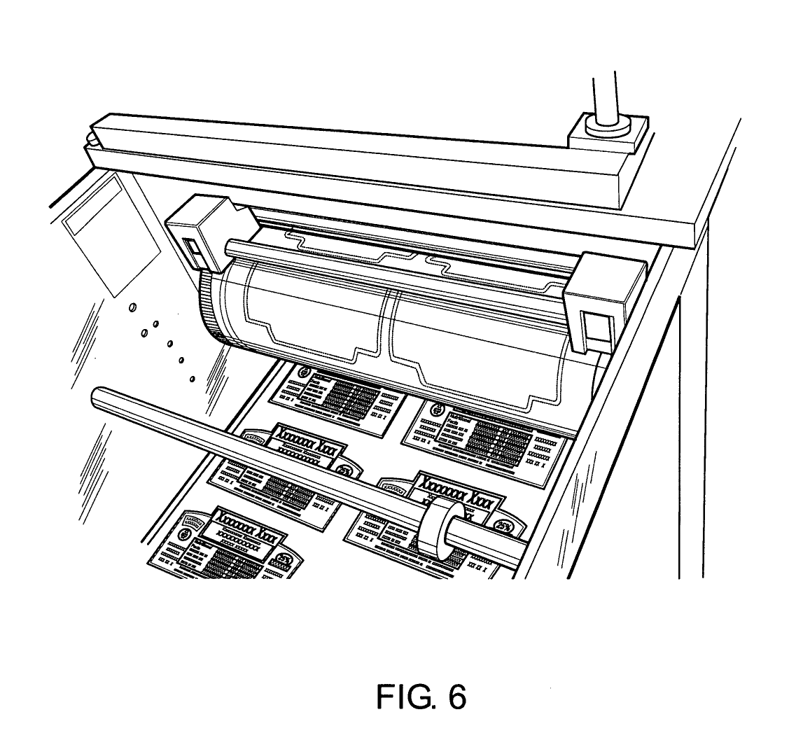

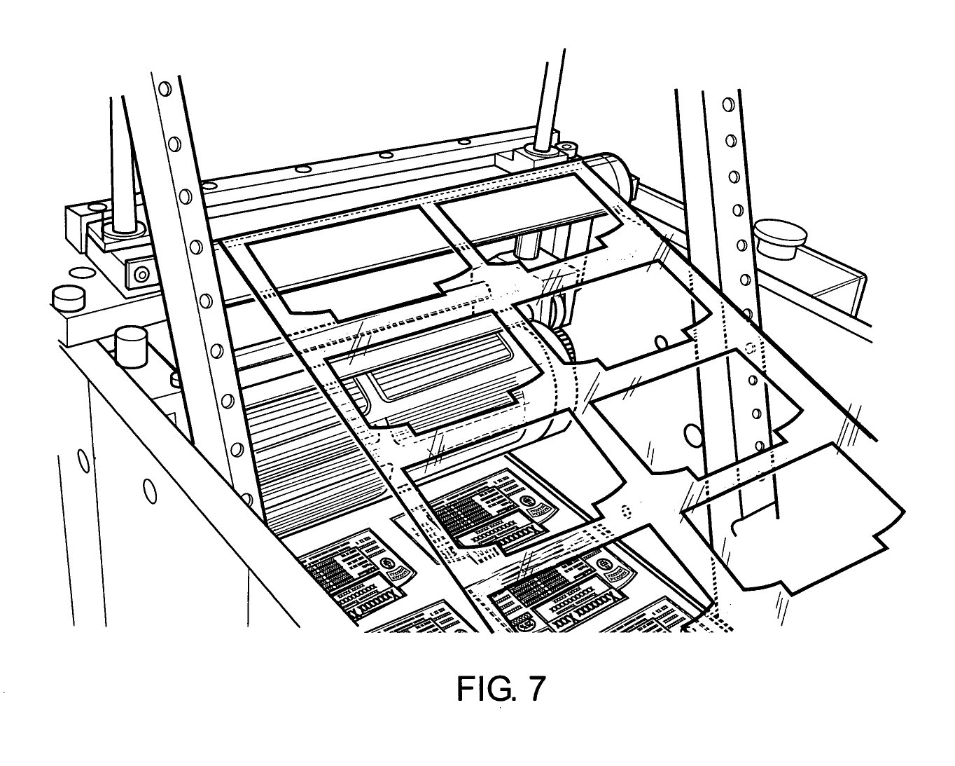

Following the UV treatment, an adhesive-backed 20 laminate 22 is applied to the entire front surface of the label (see FIG. 5). In the preferred embodiment, the laminate is 2 mm thick and acrylic based. Following application of the laminate 22, the portion of the laminate 22 which covers the customer print portion 14 of the label is removed by use of a die. This die is specifically designed to cut (see FIG. 6) only through the laminate 22 (and not through the stock 18 or liner 10) around the customer print portion 14 of the label such that it can be removed (see FIG. 7). The laminate 22 covering the remainder of the label, i.e., the preprinted portion 12, is left in place.

Following removal of the laminate 22 covering the customer print portion 14 of the label, excess stock 18 may be removed using a die for this purpose. In this preferred step, the die cuts through the laminate 22 and the stock 18 around the preprinted portion 12 and the customer print portion 14, leaving the liner 10 with the label attached. This facilitates removal of the label from the liner 10 by the customer.

Both dies used in the preceding steps are RD 90 dies provided by Rotometrics designed to cut the required layers.

With respect to the ink used in the preferred embodiment of the invention, any type of printing ink appropriate for use with labels on food packaging is acceptable. The ink preferably used is standard water based ink. This is appropriate for situations where the ink is in indirect contact with the food.

It is important to control the speed at which the stock 18 moves through the printing press. To allow removal of the laminate 22 from the customer print portion 14 of the label prior to the adhesive setting, the speed is preferably in the range of 160-180 feet per minute.

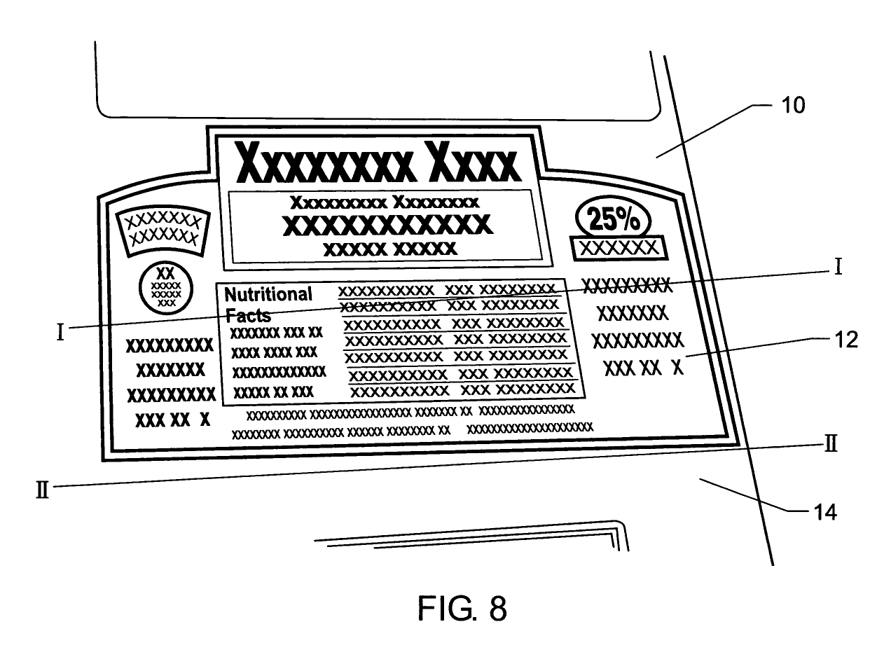

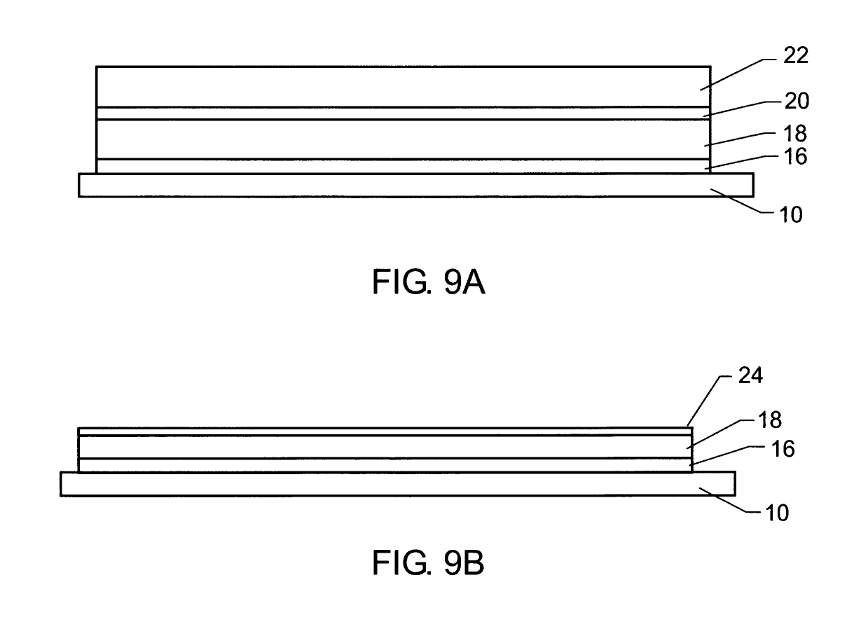

The completed label is shown in FIGS. 8 and 9. The preprinted laminated portion 12 of the label is protected when received by the customer. The customer print portion 14 of the label may be printed as desired by the customer. The label remains on the liner 10 until removed by the consumer. As shown in FIG. 9A, the preprinted laminated portion 12 of the label consists of the following layers: the liner 10, the adhesive backed stock 16,18, and the adhesive backed laminate 20, 22. As shown in FIG. 9B, the customer printed portion 14 of the label consists of the following layers: the liner 10, the adhesive backed stock 16,18, and the UV treatment 24.

Obviously, many modifications may be made without departing from the basic spirit of the present invention. Accordingly, it will be appreciated by those skilled in the art that within the scope of the appended claims, the invention may be practiced other than has been specifically described herein. Many improvements, modifications, and additions will be apparent to the skilled artisan without departing from the spirit and scope of the present invention as described herein and defined in the following claims.

What is claimed is:

1. A label assembly, comprising:
a first layer comprising an adhesive-backed stock layer having front and back opposite faces, the adhesive-backed face being attached to a liner, wherein both the front and back of the stock layer are capable of accepting printed information;
a UV varnish layer applied to a portion of the front face of the stock layer; and
a laminate layer applied to the front surface of the stock layer such that the laminate layer may be removed from the portion of the front face of the stock layer to which the UV varnish layer has been applied and such that the laminate layer adheres to the remaining portion of the front face of the stock layer to which the UV varnish layer has not been applied.

2. The assembly as set forth in claim 1 wherein the stock layer is approximately 4 millimeters in thickness.

3. The assembly as set forth in claim 1 wherein the adhesive backing for the stock layer is approximately 2 millimeters in thickness.

4. The assembly as set forth in claim 1 wherein the adhesive backing is an acrylic base adhesive.

5. The assembly as set forth in claim 1 wherein the laminate layer is approximately 2 millimeters in thickness.

6. The method as set forth in claim 1 wherein the laminate layer is acrylic based.

7. A method for producing a printable label, comprising:
providing a first layer having an adhesive-backed stock layer attached to a liner;
separating the liner from the stock layer;
printing data on the adhesive-backed stock layer
relaminating the liner to the adhesive backed stock layer;
applying a UV varnish layer to a portion of the front face of the stock layer;
applying a laminate layer to the front surface of the stock layer; and
removing the laminate layer from the portion of the front face of the stock layer to which the UV varnish was applied.

8. The method as set forth in claim 7 wherein the stock layer is approximately 4 millimeters in thickness.

9. The method as set forth in claim 7 wherein the adhesive backing for the stock layer is approximately 2 millimeters in thickness.

10. The method as set forth in claim 7 wherein the adhesive backing for the stock layer is an acrylic base adhesive.

11. The method as set forth in claim 7 wherein the laminate layer is approximately 2 millimeters in thickness.

12. The method as set forth in claim 7 wherein the laminate layer is acrylic based.
